(19) United States
(12) Patent Application Publication
(10) Pub. No.: US 2025/0369259 A1
(43) Pub. Date: Dec. 4, 2025

(54) LOCKING DEVICE FOR USE WITH DRAWER ASSEMBLIES AND METHOD OF USE

(71) Applicant: Valley Interlock, LLC, Apple Creek, OH (US)

(72) Inventor: Leroy D. Miller, Apple Creek, OH (US)

(73) Assignee: Valley Interlock, LLC, Apple Creek, OH (US)

(21) Appl. No.: 18/731,789

(22) Filed: Jun. 3, 2024

(51) Int. Cl. E05B 65/465

(52) U.S. Cl. CPC E05B 65/465

(57) ABSTRACT

A safety device for a piece of furniture includes a rod installed near a front interior corner of the piece of furniture having drawers that move, one-at-a-time, between open and closed positions. The rod has rods actuators selectively affixed thereto at positions dictated by the placement of a plurality of interlocking devices, wherein one interlocking device is installed on each drawer. The extraction and closure of a drawer causes the interlocking device on the drawer to interact with a rod actuator, thereby imparting rotation to rod. The rotation of rod causes the other drawers to be locked and prevented from being fully opened. The safety device may also have a position setting assembly defined by at least one string that extends through the back of the piece of furniture. This string allows the user to selectively lock and unlock the drawers.

### TECHNICAL FIELD

This present disclosure relates generally to safety devices for use with furniture to prevent more than one compartment from being accessible at one time.

### BACKGROUND ART

In contemporary furniture design, ensuring safety and stability is paramount, particularly with regard to furniture pieces prone to movement or tipping, such as bookcases, cabinets, and dressers. For example, when more than one drawer of a furniture piece is opened, a center of gravity of the furniture can shift significantly, amplifying a risk of instability and tipping over (e.g., as more drawers are opened, leverage exerted on the furniture piece increases, making the furniture piece more susceptible to tipping over).

Around the year 2000, an industry standard laid the groundwork for dresser stability and continues to influence safety practices. The standard applies to dressers that are 27 inches or taller. Its primary objective is to ensure that these tall furniture pieces remain upright and do not tip over easily. To meet this requirement, dressers must withstand a specific test: remaining stable when a 50-pound weight is hung on a single open drawer, while the other drawers remain closed. The expectation is that even with one drawer extended, the dresser should not tip over. While this existing standard provided a baseline for safety, recent developments have significantly expanded dresser stability.

The STURDY Act (Stop Tip-overs of Unstable, Risky Dressers on Youth) was signed into law in December 2022; see 16 CFR Part 1261. The STURDY Act represents a response to the alarming number of tip-over incidents involving dressers and other clothing storage units. The STURDY Act specifically targets clothing storage units, including dressers, armoires, and wardrobes. It recognizes that these pieces of furniture are common in households and can be hazardous if not properly designed and secured. The STURDY Act mandates that clothing storage units meet specific performance requirements. These requirements focus on stability, especially when drawers are open. Units must remain stable even with extended drawers, reducing the risk of tip-overs. The STURDY Act emphasizes protecting children up to 72 months old (6 years). Under the STURDY Act, manufacturers must rigorously test their products for stability. Dressers are evaluated under various conditions, including loaded drawers and multiple drawers open. Manufacturers and retailers are accountable for compliance. They must design and produce units that meet the specified safety criteria, and non-compliant products may face penalties.

Subsequent to the STURDY Act, Federal Standard (ASTM F2057-23) was implemented. The U.S. Consumer Product Safety Commission (CPSC) recognized the critical need to address the safety risks associated with furniture, particularly dressers, armoires, and other clothing storage units. These tall and heavy pieces of furniture can pose a significant danger, especially in households with young children. The adoption of the ASTM F2057-23 standard as a mandatory safety requirement represents a step forward in safeguarding consumers.

The ASTM F2057-23 standard focuses on evaluating the stability of clothing storage units under various conditions. The ASTM F2057-23 standard assesses how well the unit maintains stability when placed on carpeting. Dressers are tested with loaded drawers to simulate real-world scenarios. The ASTM F2057-23 standard also considers situations where multiple drawers are open simultaneously. The final rule implementing the ASTM F2057-23 standard became effective on Sep. 1, 2023. From this date forward, manufacturers and retailers must comply with the specified safety requirements.

### SUMMARY OF THE INVENTION

Having recognized the need to better comply with the relevant standards and safety requirements, embodiments of the present disclosure provide an interlock assembly that may include a first interlocking device, a second interlocking device, a rod, a first rod actuator, a second rod actuator, and a position setting assembly. These collectively operate to ensure that only a single compartment or drawer in a piece of furniture, such as a dresser, is open or accessible at one time.

In one aspect, an exemplary embodiment of the present disclosure may provide an interlock assembly for interlocking a set of drawers slidably received in a piece of furniture, the interlock assembly comprising: a rod extending vertically within the piece of furniture between an outer wall and the set of drawers; a first rod actuator affixed to the rod; a second rod actuator affixed to the rod at a different portion of the rod than the first rod actuator; a first interlocking device mounted a first drawer to interact with the first rod actuator; a second interlocking device mounted on a second drawer to interact with the second rod actuator; wherein movement of one of the first rod actuator or the second rod actuator cause the rod to rotate to thereby move the other of the first rod actuator or the second rod actuator to a locked position thereby preventing one of the drawers to be opened.

This exemplary embodiment or another exemplary embodiment may further include a position setting assembly coupled to one of the rod actuators. The position setting assembly may be coupled to the first rod actuator. The position setting assembly may include a first string having two ends, wherein one end of the first string is coupled to the first rod actuator and another end of the first string extends through a hole in a wall of the piece of furniture that is adapted to be accessible and pulled by a user to impart movement to the first rod actuator. There may also be a second string having two ends, wherein one end of the second string is coupled to the first rod actuator and another end of the second string extends through another hole in the wall of the piece of furniture that is adapted to be accessible and pulled by a user to impart movement to the first rod actuator in a different direction than the first string.

In one aspect, an exemplary embodiment of the present disclosure may provide an interlock assembly for interlocking a set of drawers slidably received in a piece of furniture, the interlock assembly comprising: a rod extending vertically within the piece of furniture between an outer wall and the set of drawers; a first rod actuator affixed to the rod; a second rod actuator affixed to the rod at a different portion of the rod than the first rod actuator; a first interlocking device mounted a first drawer to interact with the first rod actuator; a second interlocking device mounted on a second drawer to interact with the second rod actuator; wherein movement of one of the first rod actuator or the second rod actuator cause the rod to rotate about a central axis to thereby move the other of the first rod actuator or the second rod actuator to a locked position thereby preventing one of the drawers from being opened. This exemplary embodiment or another exemplary embodiment may further provide a position setting assembly coupled to one of the rod actuators. This exemplary embodiment or another exemplary embodiment may further provide that the position setting assembly is coupled to the first rod actuator. This exemplary embodiment or another exemplary embodiment may further provide that the position setting assembly includes a first string having two ends, wherein one end of the first string is coupled to the first rod actuator and another end of the first string extends through a hole defined in a rear wall the piece of furniture that is adapted to be accessible and pulled by a user to impart movement to the first rod actuator. This exemplary embodiment or another exemplary embodiment may further provide a second string having two ends, wherein one end of the second string is coupled to the first rod actuator and another end of the second string extends through the rear wall of the piece of furniture that is adapted to be accessible and pulled by a user to impart movement to the first rod actuator in a different direction than the first string.

This exemplary embodiment or another exemplary embodiment may further provide that the rod further includes a generally C-shaped body extending between a top end and a bottom end. This exemplary embodiment or another exemplary embodiment may further provide a first terminal end of the generally C-shaped body; a second terminal end of the generally C-shaped body; a slot defined between the first terminal end and the second terminal end; and an interior bore defined by an inner surface of the generally C-shaped body, wherein the slot is in open communication with the interior bore. This exemplary embodiment or another exemplary embodiment may further provide a first dimension of the slot that is measured between the first terminal end and the second terminal end; and a second dimension of the interior bore measured through a center thereof, wherein the second dimension is greater than the first dimension. This exemplary embodiment or another exemplary embodiment may further provide a central aperture defined in the first actuator, wherein the rod is disposed within the central aperture; a secondary aperture defined in the first actuator that is adapted to receive a connector therethrough to extend into the slot of the rod; wherein first rod actuator is selectively positioned along the length of the rod and affixed in place by installation of the connector. This exemplary embodiment or another exemplary embodiment may further provide that the first terminal end and the second terminal end are flat and coplanar with each other.

This exemplary embodiment or another exemplary embodiment may further provide a first arm that extends radially outward from a central aperture; and a second arm that extends radially outward from the central aperture, wherein the first arm is approximately 90 degrees from the second arm.

This exemplary embodiment or another exemplary embodiment may further provide that the rod is installed adjacent to an interior front corner of the furniture piece. This exemplary embodiment or another exemplary embodiment may further provide that the set of drawers rod are closed, the rod, the first actuator, and the second actuator are all positioned forwardly from each rear wall on the set of drawers.

In yet another aspect, an exemplary embodiment of the present disclosure may provide a method for an interlocking assembly on a piece of furniture, the method comprising: pulling a first drawer from a closed position toward an open position; moving a first interlocking device installed on the first drawer toward a first rod actuator installed on a rod positioned near an interior front corner of the piece of furniture; contacting the first interlocking device with a first arm of the first rod actuator; rotating the rod about a central axis of the rod in response to moving the first interlocking device past the first rod actuator, wherein rotation of the rod causes a second rod actuator to rotate; precluding substantial movement of a second drawer by a second arm of the second rod actuator interfering with a second interlocking device installed on the second drawer to thereby prevent the second drawer from being fully opened when the first drawer is in the open position.

This exemplary embodiment or another exemplary embodiment may further provide pushing the first drawer from the open position into the piece of furniture toward the closed position; moving the first interlocking device installed on the first drawer toward the first rod actuator installed on the rod positioned near the interior front corner of the piece of furniture; contacting the first interlocking device with a second arm of the first rod actuator; and rotating the rod in an opposite direction about the central axis of the rod in response to moving the first interlocking device past the first rod actuator, wherein rotation of the rod causes the second rod actuator to rotate and reset the rod into an unlocked state.

This exemplary embodiment or another exemplary embodiment may further provide pulling the second drawer from a closed position toward an open position; moving the second interlocking device installed on the second drawer toward the first rod actuator installed on the rod positioned near the interior front corner of the piece of furniture; contacting the second interlocking device with a first arm of the second rod actuator; rotating the rod about the central axis of the rod in response to moving the second interlocking device past the second rod actuator, wherein rotation of the rod causes the first rod actuator to rotate; and precluding substantial movement of the first drawer by a second arm of the first rod actuator interfering with the first interlocking device installed on the first drawer to thereby prevent the first drawer from being fully opened when the second drawer is in the open position.

In yet another aspect, another exemplary embodiment of the present disclosure may provide a method of assembly for an interlocking assembly on a piece of furniture, the method comprising: providing a rod defining a slot along a length of the rod; moving a first rod actuator along the length of the rod; selecting a position along the length of the rod to install the first rod actuator; affixing the first rod actuator to the rod; moving a second rod actuator along the length of the rod; selecting another position along the length of the rod to install the second rod actuator; affixing the second rod actuator to the rod; and installing the rod with the affixed first and second rod actuators within the piece of furniture near an interior front corner between an interior surface of a sidewall and a set of drawers. This exemplary embodiment or another exemplary embodiment may further provide inserting a connector through the first rod actuator and into the slot; and inserting a second connector through the second rod actuator and into the slot. This exemplary embodiment or another exemplary embodiment may further provide determining a dimensional distance between the first interlocking device and the second interlocking device; and affixing the first rod actuator and the second rod actuator at respective positions along the length of the rod based on the dimensional distance between the first interlocking device and the second interlocking device.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a perspective view on an interior compartment of a piece of furniture.

FIG. 2 (FIG. 2) is a perspective view of drawers on the piece of furniture detailing the first interlocking device and the second interlocking device.

FIG. 3 (FIG. 3) is a top plan view of the interlock assembly relative to one of the drawers.

FIG. 4A (FIG. 4A) is an operational top plan view depicting the first interlocking device and first rod actuator in a locked position.

FIG. 4B (FIG. 4B) is an operational top plan view of a string being pulled to move the first interlocking device into an unlocked position.

FIG. 4C (FIG. 4C) is an operational top plan view of a drawer being opened with the first interlocking device in the unlocked position.

FIG. 4D (FIG. 4D) is an operation top plan view of another drawer prevented from being opened when the second interlocking device has been moved to the locked position.

FIG. 5 (FIG. 5) is a cross section view of one exemplary configuration of the rod.

Similar numbers refer to similar parts throughout the drawings.

### DETAILED DESCRIPTION

While safety devices are sometimes employed to prevent furniture pieces from tipping over, typical safety devices often face significant challenges and limitations. For example, a common issue arises in ensuring their effectiveness across diverse furniture types and materials, where variations in size, weight, and construction can affect reliability. Furthermore, user error or improper installation may undermine the efficacy of typical safety devices. Consistency in standards and regulations across manufacturers also presents a hurdle, given potential disparities in design or quality control that can impact safety device reliability. Moreover, as furniture design progresses and new materials and technologies emerge, ensuring the compatibility and durability of typical safety devices remains an ongoing concern.

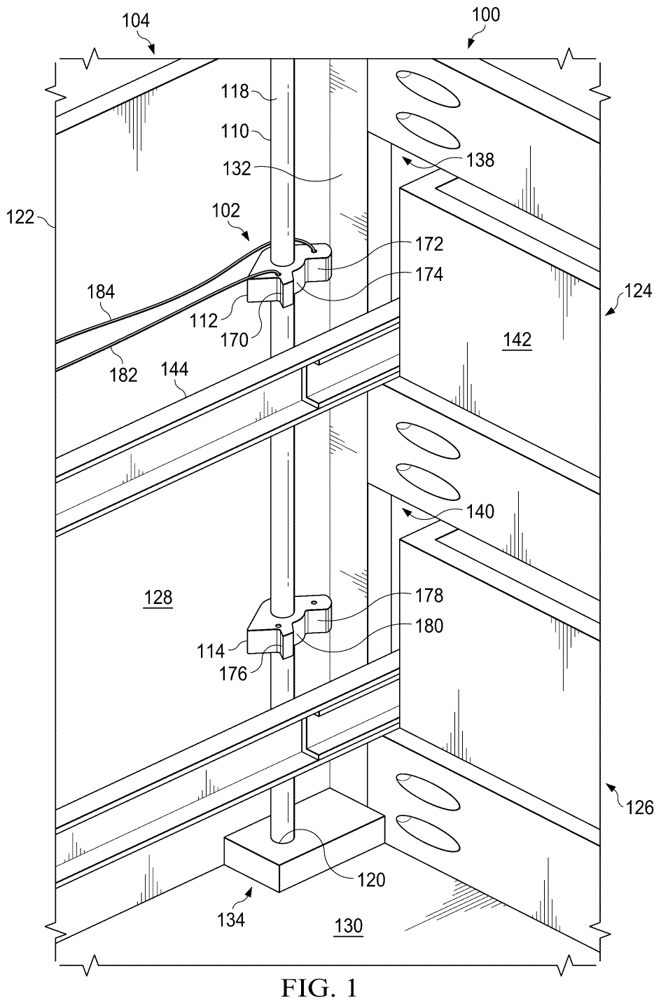

FIGS. 1-5 are diagrams of an exemplary safety locking device or assembly 100 associated with interlocking a set of drawers of a furniture piece (e.g., to prevent one or more drawers from being opened, as described in more detail elsewhere herein). As shown in FIGS. 1-5, the safety locking device or assembly 100 includes an interlock assembly 102 and a furniture piece 104.

The interlock assembly 102 includes a first interlocking device 106, a second interlocking device 108, a rod 110, a first rod actuator 112, a second rod actuator 114, and a position setting assembly 116. The rod 110 includes a top end 118 opposite a bottom end 120. The rod 110 extends for a length between the top end 118 and the bottom end 120. The rod 110 is rotatable about a rotation axis that extends centrally along the length of the rod 110 (e.g., the rod is rotatable about the rotation axis in a first direction and a second direction that is opposite to the first direction, as described in more detail elsewhere herein).

The furniture piece 104 includes a frame 122, a first drawer assembly 124 and at least a second drawer assembly 126. Notably, while the exemplary furniture piece 104 is shown with two drawer assemblies 124 and 126, it is to be understood that the interlock assembly 102 can be expanded to accommodate a piece of furniture with any number of drawers. For example, many dressers have three, four or five drawers. The frame 122 includes interior surfaces (e.g., shown as an interior side surface 128, a bottom surface 130, and a front interior surface 132 in FIGS. 1-6E) that define an interior region 134. The frame 122 further includes a front end 136 defining a first opening 138 and a second opening 140, each of which leading to the interior region 134. The rod is positioned closely adjacent to the front interior surface 132. In one embodiment, the rod 110 is positioned inward from the interior side surface 128 next to the front interior surface 132. This positions the rod 110 in or near a forward corner of the furniture piece 104, wherein the forward corner is defined relative to a user's perspective when using the furniture. In one particular embodiment, by placing the rod 110 in the forward corner of the furniture piece 104, this allows the assembly 100 to be user under undermount rail assemblies. It is believe that previous safety locking devices could only be placed in the rear side of the furniture piece when used in conjunction with undermount rail assemblies.

As shown in FIGS. 1-5, the first drawer assembly 124 includes a first drawer 142 and a first rail assembly 144 (e.g., a first side-mounted rail assembly) and the second drawer assembly 126 includes a second drawer 146 and a second rail assembly 148 (e.g., a second side-mounted rail assembly). While the first rail assembly 144 and the second rail assembly 148 are depicted as side-mounted rail assemblies, it is to be understood that undermounted rail assemblies can be used with the safety device or assembly 100 of the present disclosure. Recall, previous safety devices required the safety device to be mounted in the rear portion of the furniture when an undermount rail was utilized.

The first drawer 142 and the second drawer 146 are each movable between a closed position and an open position (e.g., the first drawer 142 is movable, into and out of the first opening 138, between the closed position and the open position via a first travel axis defined by the first rail assembly 144 and the second drawer 146 is movable, into and out of the second opening 140, between the closed position and the open position via a second travel axis defined by the second rail assembly 148). In other words, the first drawer 142 and the second drawer 146 are movable in an opening direction (e.g., from the closed position to the open position) and are movable in a closing direction (e.g., from the open position to the closed position).

Although the first drawer assembly 124 is described as including the first drawer 142 and the first rail assembly 144 and the second drawer assembly 126 is described as including the second drawer 146 and the second rail assembly 148, the first drawer assembly 124 and the second drawer assembly 126 may include any suitable components, such as track assemblies and/or undermount assemblies, among other examples.

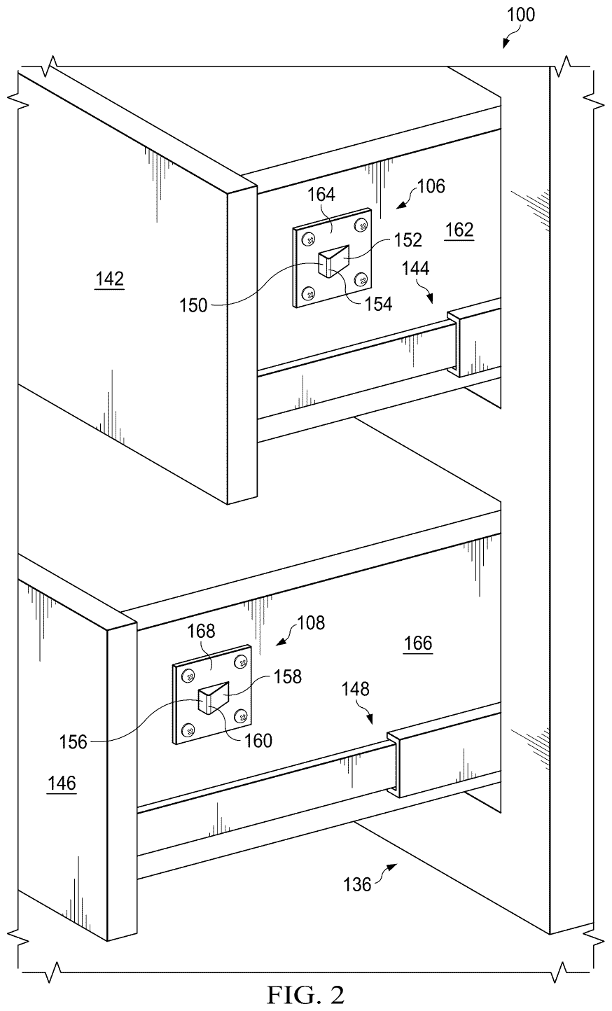

As shown in FIGS. 2-5, the first interlocking device 106 includes a first interlocking surface 150, a first contacting surface 152, and a first beveled portion 154, and the second interlocking device 108 includes a second interlocking surface 156, a second contacting surface 158, and a second beveled portion 160. The first interlocking device 106 is mounted to a first drawer side surface 162 via a first mount 164. The second interlocking device 108 is mounted to a second drawer side surface 166 via a second mount 168.

As further shown in FIGS. 2-5, the first interlocking surface 150 is a substantially flat surface that extends a distance from the first mount 164 to the first beveled portion 154 such that the first interlocking surface 150 faces a direction that is toward the first opening 138. In one exemplary embodiment, the first interlocking surface is orthogonal to the primary planar surface of the mount 164. The first contacting surface 152 is a substantially flat surface that extends from the first beveled portion 154 to the first mount 164 at an angle. Collectively, the first interlocking surface 150, the first contacting surface 152, and the first beveled portion 154 form a generally triangularly shaped member notwithstanding the small first beveled portion 154 to that prevents them from forming a true triangular member.

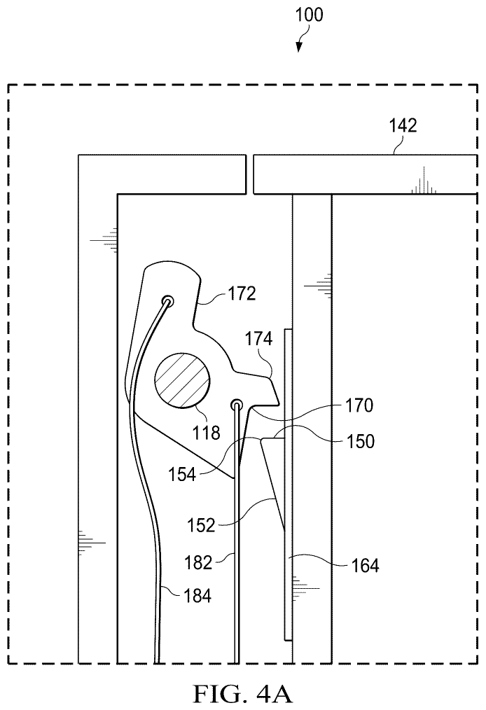

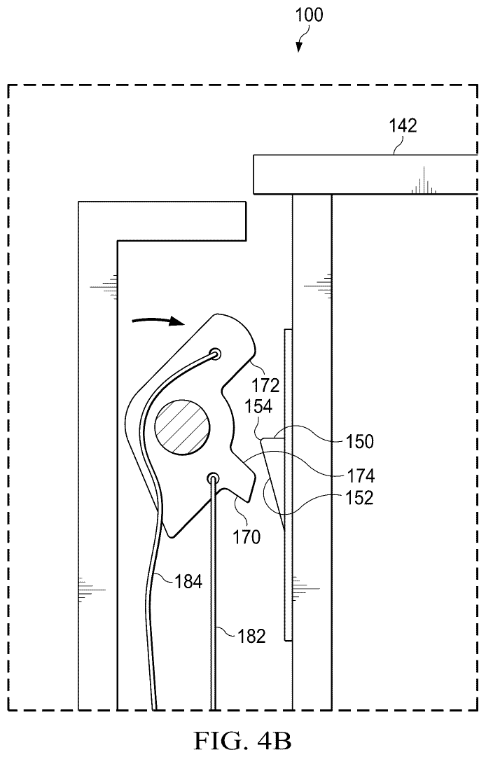

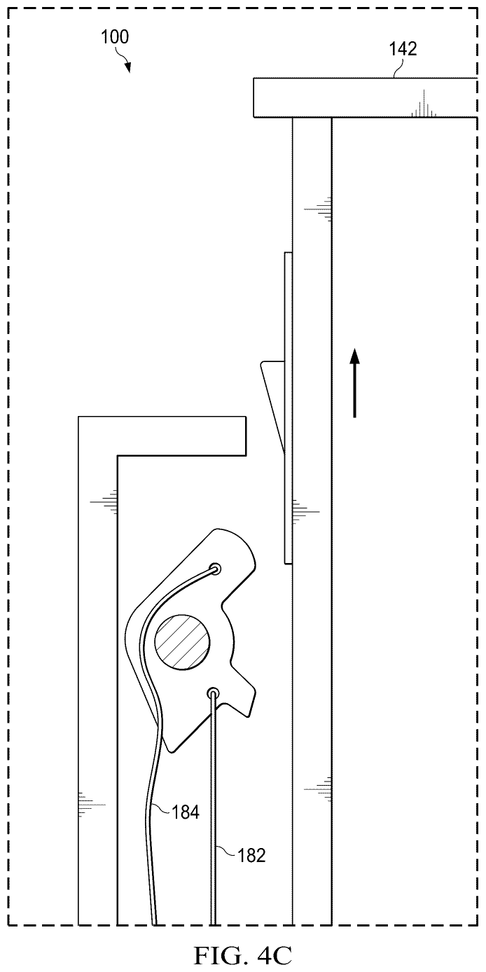

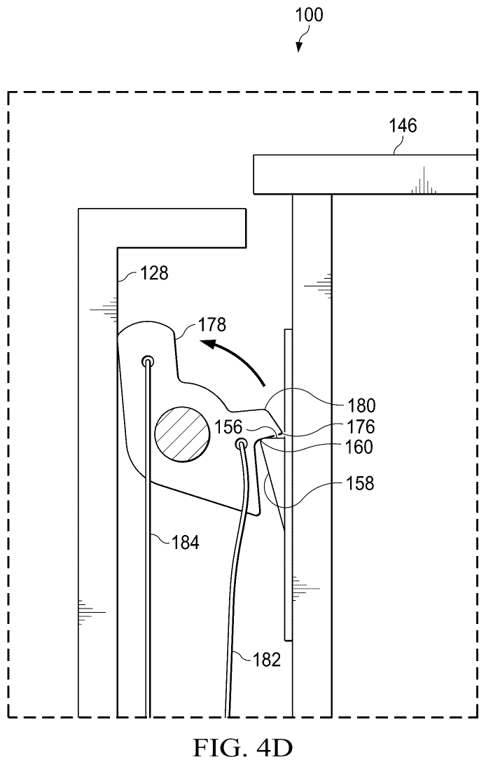

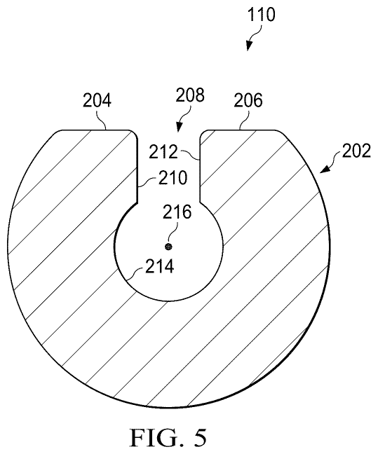

As further shown in FIGS. 2-5, the second interlocking surface 156 is a substantially flat surface that extends a distance from the second mount 168 to the second beveled portion 160 such that the second interlocking surface 156 faces a direction that is toward the second opening 140. The second contacting surface 158 is a substantially flat surface that extends from the second beveled portion 160 to the second mount 168 at an angle. Collectively, the second interlocking surface 156, the second contacting surface 158, and the second beveled portion 160 form a generally triangularly shaped member notwithstanding the small first beveled portion 154 to that prevents them from forming a true triangular member. Accordingly, the first interlocking device 106 and the second interlocking device 108 may take on a wedge shape (e.g., when viewed from above, such as in FIGS. 4A-5).

As shown in FIGS. 1, 3-5, the rod 110 is mounted to the interior side surface 128 proximate the first rail assembly 144 and the second rail assembly 148 such that the rotation axis of the rod 110 is substantially perpendicular to the first travel axis of the first drawer (e.g., defined by the first rail assembly 144) and the second travel axis of the second drawer (e.g., defined by the second rail assembly 148). Rod 110 may have a circular or generally circular profile in the exemplary embodiment. More particularly, FIG. 5 depict that one embodiment of the rod 110 has a generally C-shaped cross sectional configuration defining a slit that runs parallel to the length of the rod 110. However, other perimeter configurations of the rod 110 are possible so long as rod 110 still rotates about its axis. For example, a square rod could be utilized instead of a circular rod. Rod 110 may be installed between the rails 144 and the side of the frame 122 of the dresser. This positions the rod 110 in a manner so as to not disrupt the path of travel of the drawers 142 and 146. Further, although not shown, it is to be understood that the top 118 and bottom 120 of rod 110 may be secured to appropriate mounting brackets that effectuate rotation of the rod 110 about its longitudinal axis while remaining secured to the furniture piece 104.

As shown in FIGS. 1, 3-5, the first rod actuator 112 includes a first interlocking portion 170, a first locking portion 172, and a first unlocking portion 174. The second rod actuator 114 includes a second interlocking portion 176, a second locking portion 178, and a second unlocking portion 180.

In one embodiment, first rod actuator 112 includes a solid unibody that can be fabricated from a rigid material, such as a hard polymer/plastic, or metal. The body defines the components of the rod actuator 112. For example, the body can have an aperture extending fully through the body from the top surface to the bottom surface that is configured to accept, accommodate, or receive the rod 110 therethrough. A portion of the body can have another screw-hole aperture that is orthogonal to the primary central aperture, wherein the screw-hole aperture is configured to receive a screw through that mounts the actuator 112 to the rod 110. In other embodiments, the rod 110 and the body of the first rod actuator 112 may be affixed together in any known manner. The aperture has a profile that complements or generally complements the exterior profile of the rod 110. For example, when the rod 110 has a circular profile, then the profile of the aperture will also be circular. Still, when the rod 110 has a generally C-shaped profile, then the profile of the aperture could still be circular as the C-shaped profile of rod 110 would still fit within the central primary aperture of actuator 112. However, if the rod was a square rod, then the actuator 112 would have a square aperture. The body of the first rod actuator 112 further defines a first arm that extends outward from the central aperture. On this first arm, one surface defines the first interlocking portion 170 and another surface defines the first unlocking portion 174. The body of the first rod actuator 112 further defines a second arm that extends outward from the central aperture. On this second arm, one surface defines the first locking portion 172. An angle of approximately 90 degrees is defined between the first arm and the second arm on the body of the first rod actuator 112.

Second rod actuator 114 includes a solid body that can be fabricated from a rigid material. Typically, second rod actuator 114 will be made from the same material as the first rod actuator 112. The body of the second rod actuators 114 defines the components of the second rod actuator 114 and is identical to the first rod actuator 112. For example, the body can have an aperture extending fully through the body from the top surface to the bottom surface that is configured to accept, accommodate, or receive the rod 110 therethrough. Then, the rod 110 and the body of the second rod actuator 114 may be affixed together in any known manner. The aperture has a profile that complements the exterior profile of the rod 110. For example, when the rod 110 has a circular or C-shaped profile, then the profile of the aperture will also be circular. However, if the rod was a square rod, then the actuator 114 would have a square aperture. The body of the second rod actuator 114 further defines a first arm that extends outward from the central aperture. On this first arm, one surface defines the second interlocking portion 176 and another surface defines the second unlocking portion 180. The body of the second rod actuator 114 further defines a second arm that extends outward from the central aperture. On this second arm, one surface defines the second locking portion 178. An angle of approximately 90 degrees is defined between the first arm and the second arm on the body of the second rod actuator 114.

In some implementations, the first rod actuator 112 is selectively and fixedly coupled to the rod 110 at a first location along the length of the rod 110 and the second rod actuator 114 is selectively and fixedly coupled to the rod 110 at a second location that enable the first interlocking device 106 to interact with the first rod actuator 112 and the second interlocking device 108 to interact with the second rod actuator 114, as described in more detail elsewhere herein. Due to the affixed configuration of the actuators 112 and 114 to the rod 110, when the rod 110 rotates about its axis, the actuators 112 and 114 also rotate about the axis in unison. The selective fixed attachment of the actuators 112 and 114 to the rod 110 enable the security device or assembly 100 to be used with any size furniture piece 104. More particularly, the configuration of rod 110, which is described in greater detail below, allows the actuators 112 and 114 to be fixed secured along the length thereof at any selected distance based on the user determined size parameters of the furniture piece. This is advantageous as it allows safety assembly 100 to be installed on any custom built furniture piece 104, as opposed to only operating within a fixed dimensional requirement.

As an example, and as shown in FIG. 1, the first rod actuator 112 is fixedly coupled to the rod 110 at a first location along the length of the rod 110 such that the first interlocking surface 150 and the first beveled portion 154 of the first interlocking device 106 may interact with the first interlocking portion 170 and the first locking portion 172 of the first rod actuator 112 and the first contacting surface 152 of the first interlocking device 106 may interact with the first unlocking portion 174 of the first rod actuator 112, as described in more detail elsewhere herein.

As another example, and as shown in FIG. 1, the second rod actuator 114 is fixedly coupled to the rod 110 at a second location along the length of the rod 110 such that the second interlocking surface 156 and the second beveled portion 160 of the second interlocking device 108 may interact with the second interlocking portion 176 and the second locking portion 178 of the second rod actuator 114 and the second contacting surface 158 of the second interlocking device 108 may interact with the second unlocking portion 180 of the second rod actuator 114, as described in more detail elsewhere herein.

Because the first rod actuator 112 and the second rod actuator 114 are fixedly coupled to the rod 110 (e.g., fixedly attached to the rod 110), forces applied to the first rod actuator 112 or the second rod actuator 114 cause the rod 110 to rotate in the first direction or the second direction, as described in more detail elsewhere herein. When the rod 110 moves in the first direction (i.e., either clockwise or counterclockwise), the first rod actuator 112 and the second rod actuator 114 move to a locked position. When the rod 110 moves in the second direction (i.e., the other of clockwise or counterclockwise), the first rod actuator 112 and the second rod actuator 114 move into an unlocked position.

The first rod actuator 112 is coupled to the rod 110 at a first location along the length of the rod 110 and the second rod actuator 114 is coupled to the rod 110 at a second location. This enables the first interlocking device 106 to interact with the first rod actuator 112 and the second interlocking device 108 to interact with the second rod actuator 114, which move the first rod actuator 112 or the second rod actuator 114, respectively, into the locked position or the unlocked position, as described in more detail elsewhere herein.

For example, when the first rod actuator 112 is in the unlocked position and the first drawer 124 is opened (i.e., pulled outward from the dresser), the first interlocking device 106 may move past the first interlocking portion 170 such that the first interlocking surface 150 and the first beveled portion 154 of the first interlocking device 106 contact and apply a force to the first locking portion 172. The force of contact causes the causes the rod 110, the first rod actuator 112, and the second rod actuator 114 to rotate in the counterclockwise direction until the first rod actuator 112 and the second rod actuator 114 move into the locked position after the first interlocking device 106 on the first drawer 142 has moved past the first rod actuator 112.

Thereafter, the second drawer 146 is prevented from being opened via the interaction between the second interlocking device 108 and the second rod actuator 114 (e.g., the second interlocking surface 156 and the second beveled portion 160 of the second interlocking device 108 are engaged with the second interlocking portion 176 of the second rod actuator 114). In this way, the second drawer 146 is prevented from being moved from the closed position to the open position (e.g., at least until the first drawer 142 moves from the open position to the closed position).

The first drawer 142 moves in the closing direction (e.g., until the first contacting surface 152 of the first interlocking device 106 contacts and applies a force to the first unlocking portion 174 of the first rod actuator 112. The force of contact causes the causes the rod 110, the first rod actuator 112, and the second rod actuator 114 to rotate in the clockwise direction until the first rod actuator 112 and the second rod actuator 114 move into the unlocked position. Once the rod 110 is in the unlocked position, another drawer may then be opened and the process repeats to allow one drawer to be opened, wherein the opening of one drawer effectuates the locking of the other drawers.

As shown in FIGS. 1, 3-5, in one exemplary embodiment the position setting assembly 116 can be used by the user to selectively unlock or selectively lock the actuators 112 and 114. This could be beneficial for a user to selectively lock all of the drawers 142 and 146 should it be desirable to prevent all of them from being opened. Further, the user can reset each of the drawers to the unlocked position when they are all closed. This will allow the user to select a new or different drawer to be opened, which in turn would then lock and prevent the other drawers from being opened.

The position setting assembly 116 includes a first string 182 and a second string 184. The first string 182 is coupled proximate to the first interlocking portion 170 and the first unlocking portion 174 in order to set the position of the first rod actuator 112. The second string is coupled to the first rod actuator 112 proximate to the first locking portion 172. At the other end of the strings 182 and 184, the first string 182 and the second string 184 may extend through one aperture or two different apertures in a rear surface of the furniture piece 104 to enable a user of the furniture piece 104 to apply a pulling force to the first string 182 and/or the second string 184. The first string 182 and the second string 184 may include retaining members that retain the first string 182 and the second string 184 outside of the interior region 134. Accordingly, the first interlocking portion 170 is controllable or may be placed into a user-selected orientation by the user pulling on one of the strings 182 or 184 of the position setting assembly 116. In one embodiment, the strings 182 and 184 are different colors so a user can easily see or otherwise distinguish the strings from each other. For example, the string that is used to unlock the rod 110 can be a first color and the string that is used to lock the rod 110 can be a different second color.

The first string 182 may be used to apply a pulling force on the first rod actuator 112 causing the rod 110, the first rod actuator 112, and the second rod actuator 114 to rotate in the first direction (e.g., clockwise, when viewed from above, until the first rod actuator 112 and the second rod actuator 114 move into the locked position). The second string 184 may be used to apply a pulling force on the first rod actuator 112 causing the rod 110, the first rod actuator 112, and the second rod actuator 114 to rotate in the second direction (e.g., counterclockwise, when viewed from above, until the first rod actuator 112 and the second rod actuator 114 move into the unlocked position). In this way, the first string 182 may be used to move the first rod actuator 112 and the second rod actuator 114 into the unlocked position and the second string 184 may be used to move the first rod actuator 112 and the second rod actuator 114 into the locked position. As such, use of the strings 182 and/or 184 allows a user to selective reset the assembly 100 should it ever inadvertently lock or unlock. Additionally, the strings 182 and/or 184 allow the furniture piece 104 to be locked if the user desires to lock all drawers at once, and then unlock the drawers after having been locked. Through the use of the strings 182 and/or 184, a user can operate the assembly 100 from outside the furniture piece 104 with all the drawers closed, thereby eliminating the risk of the user being locked out of their furniture. This can also function as an access lock (i.e., lock all drawers by pulling one of the strings to rotate the rod 110 and lock all the actuators).

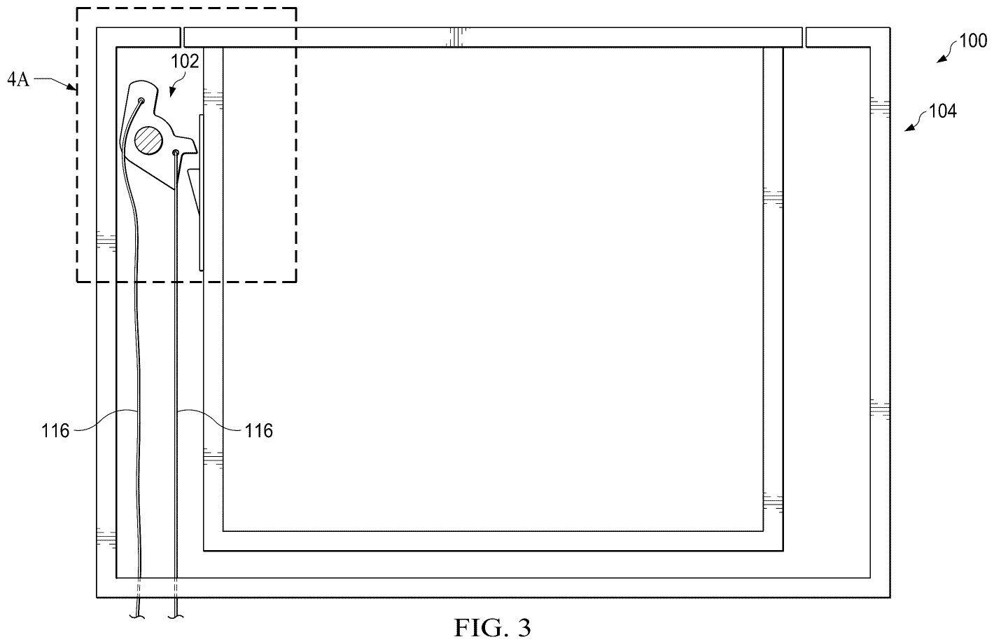

As shown in FIGS. 3 and 4A, the first rod actuator 112 is in the locked position. In the locked position, the first drawer 142 is prevented from being opened because the interlocking surface 150 and the first beveled portion 154 of the first interlocking device 106 cannot move past the first interlocking portion 170 on one of the arms of the first actuator 112.

As shown in FIG. 4B, the first rod actuator 112 has been moved from the locked position to the unlocked position. This would have been accomplished by the second drawer 126 having been moved from its open position to its closed position. When the second drawer is pushed inward and closed, the tapered surface 158 on the second interlocking device 108 would have pushed the surface on portion 180 on the second rod actuator 114 and caused the rod 110 to rotate about the longitudinal axis. Thereafter, once the actuator 112 is in the unlocked position, the first drawer 142 may be pulled outward and opened as shown in FIG. 4C.

After the first interlocking device 106 moves past the first rod actuator 112, the first interlocking surface 150 and the first beveled portion 154 of the first interlocking device 106 will have applied a sufficient force to the first locking portion 172 to move the rod to the locked position. As shown in FIG. 4D, the second drawer 126 is prevented from being opened via the interaction between the second interlocking device 108 and the second rod actuator 114 (e.g., the second interlocking surface 156 and the second beveled portion 160 of the second interlocking device 108 are engaged with the second interlocking portion 176 of the second rod actuator 114). In this way, the second drawer 126 is prevented from being moved from the closed position to the open position (e.g., at least until the first drawer moves from the open position to the closed position).

Although particular configurations of the first rod actuator 112 and the second rod actuator 114 are described in connection with FIGS. 1-4D and/or as described in more detail elsewhere herein, the first rod actuator 112 and/or the second rod actuator 114 may take on any suitable configuration.

FIG. 5 depicts a cross section of the rod 110. This exemplary configuration of rod 110 has a generally C-shaped profile when viewed in cross section. The C-shaped profile of the rod 110 extends along the length thereof from the top end 118 to the bottom end 120. When viewed in cross section, the body 202 of the rod 110 has a first terminal end 204 and a second terminal end 206. The terminal ends 204, 206 of the C-shaped body 202 may be flat and/or co-planar with each other. The terminal ends 204, 206 define a slot 208 or a slit therebetween. The slot 208 or slit has a dimension or distance defined between the surfaces 210, 212 of the terminal ends 204, 206, respectively. The dimension of the slot is narrower or less than an interior bore 214 of the rod 110 and in open communication therewith. The interior bore 214 may have a generally circular shape and is defined by the inner surface of the body 202. The inner bore 214 is aligned with a central longitudinal axis 216 of the rod 110. The second dimension associated with the interior bore 214, which is greater than the first dimension, is sized to receive a connector, such as a screw, at the top end 118 and the lower end 120 thereof. Stated otherwise, a screw is inserted along the length of the axis 216 at the end connectors in order to connect the rod 110 with those end connectors but still allow the rod to rotate about the longitudinal axis 216 when the drawers 124 or 126 are moved between there open and closed positions thereby moving the first and second actuators 112 and 114 to cause the pivoting or rotational movement of the rod 110.

The slit 208 or slot that extends along the longitudinal length of the rod 110 is configured to receive another screw therethrough. The screw that extends through the slot 208 or slit is used to connect one of the actuators 112 or 114 to the rod 110. Because the slot 208 or slit extends along the entire length of the rod 110 or substantially along the length of the rod, the actuators 112 and 114 may be selectively fixed along the length of the rod 110 at any portion thereof. This provides user-selected customization for furniture dimensions or drawer dimensions. Stated otherwise, the user can quickly and easily manufacture a custom drawer or furniture piece 104 by simply using one rod 110 and placing the actuators 112 and 114 at an appropriate length thereof that corresponds to the position of the interlocking devices 106, 108 that are mounted on the sidewalls of the drawer.

According to one aspect of the present disclosure a unique method of manufacture of a furniture piece 104 is provided. Particularly, the structural configuration of the safety device or assembly 100 enables the furniture piece 104 to be manufactured to any customized size, as opposed to a standard size, depending on the user selected or customer supplied specifications and dimensions of the furniture piece 104. Particularly, the furniture maker or manufacturer will have customer supplied dimensions of the drawers for the furniture piece 104. With those drawer dimensions provided, supplied or otherwise known, the furniture manufacturer will know and install the first and second interlocking devices 106, 108; wherein one interlocking device is on the sidewall of one drawer and another interlocking device is on the sidewall of another drawer. These two interlocking devices 106, 108 will be spaced apart from each other based on a calculated distance or dimension relative to the vertical direction. With the known separation or spaced apart distance of the two interlocking devices 106, 108, the furniture manufacturer will know the placement location along the rod 110 of the first actuator 112 and the second actuator 114. Because of the slot 208 or slit that extends along the longitudinal length of the rod 110, the user will slide the rod 110 through the primary central aperture of each actuator 112 and 114. Then, the actuators 112 and 114 will be respectively locked into position by inserting a smaller screw through the secondary aperture in the actuators 112 and 114. Inserting a screw through the secondary apertures in the actuators 112 and 114 will cause the screw to be inserted through the slot 208 or slit in the rod 110 and a terminal end or the screw will be disposed within the central primary bore 214 of the rod 110 when the rod 110 is configured as a C-shaped rod 110.

With the actuators 112 and 114 selectively secured and affixed to the rod 110, the rod 110 may be installed within the interior space of the furniture piece 104. More particularly, the rod 110 may be installed near one of the front corners of the furniture piece 104. In one particular embodiment, the rod 110 is installed near the front, right corner of the furniture piece 104. Installing the rod 110 near the front, right corner or the front, left corner is advantageous, especially when using undermount rails or rail slides are used for the drawers, because it allows the safety assembly 100 to function and cooperate with the drawers without interfering with the slide rails, especially undermount slide rails. Positioning the rod and actuators in one of the front corners of the furniture piece 104 is further advantageous because it eliminates the thermal effects on the wood from interfering with the operation of the safety device. Stated otherwise, when any safety device is installed near the rear end of the furniture piece, and when the wood expands and contracts due to varying temperatures and/or humidity, the safety device is rendered less effective because expansion and contraction of the wood of the furniture drawers and the frame of the piece of furniture vary relative to each other based on temperature and/or humidity differentials. Thus, as wood heats up it expands and can cause a rear positioned safety device to malfunction. Likewise, when the wood of the furniture piece cools it contracts and thereby creates a greater dimensional offset between those components, which could also cause the rear mounted safety device to malfunction. To eliminate this problem with the temperature and/or humidity differential, the forward mounted safety assembly 100 of the present disclosure is able to maintain the effectiveness and ability of the proper safety functioning regardless of environmental temperature and/or humidity within which the furniture piece 104 is disposed.

The slot 208 or slit formed in the rod 110 provides greater ability for the furniture manufacturer when customizing specific dimensions that are outside the conventional standard dimensions for a drawer in a furniture piece 104. Since the slot 208 or slit extends substantially along the entire length of the rod 110, the actuators 112 and 114 can be selectively placed along any dimension of the rod depending on the positioning of the interlocking devices 106, 108, which are based on the custom size dimensions of the drawers. For example, if larger drawers are required or selected by the customer, then the interlocking devices 106 or 108 on each respective drawer are known to be at a certain dimension offset relative to each other. For example, assume that the interlocking devices on two respective drawers are offset from each other by about 12 inches. Then, the manufacturer of thee furniture piece 104 will slide the first actuator 112 along the length of the rod 110 and affix that first actuator 112 to the rod by inserting a screw through the secondary aperture at a first position. Then, the manufacturer will slide the second actuator 114 along the length of the rod until the second actuator 114 is offset from the first actuator 112 to a dimension that corresponds to the dimensional offset between the two interlocking devices, which in this exemplary hypothetical is 12 inches but could be any distance that corresponds to the custom furniture dimension. Further, safety assembly 100 can be installed on an existing or legacy furniture piece to enable the legacy furniture piece to be retrofit so that can have the same safety functionality as a newly constructed and/or custom furniture piece 104.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the elements having the configurations described and shown herein, those elements could also be can be semi-circular, triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. An interlock assembly for interlocking a set of drawers slidably received in a piece of furniture, the interlock assembly comprising:
a rod extending vertically within the piece of furniture between an outer wall and the set of drawers;
a first rod actuator affixed to the rod;
a second rod actuator affixed to the rod at a different portion of the rod than the first rod actuator;
a first interlocking device mounted a first drawer to interact with the first rod actuator;
a second interlocking device mounted on a second drawer to interact with the second rod actuator; and
wherein movement of one of the first rod actuator or the second rod actuator cause the rod to rotate about a central axis to thereby move the other of the first rod actuator or the second rod actuator to a locked position thereby preventing one of the drawers from being opened.

2. The interlocking assembly of claim 1, further comprising:
a position setting assembly coupled to one of the rod actuators.

3-5. (canceled)

6. The interlocking assembly of claim 1, wherein the rod further includes:
a generally C-shaped body extending between a top end and a bottom end.

7. The interlocking assembly of claim 6, wherein the rod further includes:
a first terminal end of the generally C-shaped body;
a second terminal end of the generally C-shaped body;
a slot defined between the first terminal end and the second terminal end; and
an interior bore defined by an inner surface of the generally C-shaped body, wherein the slot is in open communication with the interior bore.

8. The interlocking assembly of claim 7, wherein the rod further includes:
a first dimension of the slot that is measured between the first terminal end and the second terminal end; and
a second dimension of the interior bore measured through a center thereof, wherein the second dimension is greater than the first dimension.

9. The interlocking assembly of claim 7, further comprising:
a central aperture defined in the first actuator, wherein the rod is disposed within the central aperture;
a secondary aperture defined in the first actuator that is adapted to receive a connector therethrough to extend into the slot of the rod;
wherein the first rod actuator is selectively positioned along a length of the rod and affixed in place by installation of the connector.

10. The interlocking assembly of claim 7, wherein the first terminal end and the second terminal end are flat and coplanar with each other.

11. The interlocking assembly of claim 1, wherein the first rod actuator comprises:
a first arm that extends radially outward from a central aperture; and
a second arm that extends radially outward from the central aperture.

12. The interlocking assembly of claim 1, wherein the rod is installed adjacent to an interior front corner of the piece of furniture.

13. The interlocking assembly of claim 1, wherein the set of drawers rod are closed, the rod, the first actuator, and the second actuator are all positioned forwardly from each rear wall on the set of drawers.

14. A method for an interlocking assembly on a piece of furniture, the method comprising:
pulling a first drawer from a closed position toward an open position;
moving a first interlocking device installed on the first drawer toward a first rod actuator installed on a rod positioned near an interior front corner of the piece of furniture;
contacting the first interlocking device with a first arm of the first rod actuator;
rotating the rod about a central axis of the rod in response to moving the first interlocking device past the first rod actuator, wherein rotation of the rod causes a second rod actuator to rotate;
precluding substantial movement of a second drawer by a second arm of the second rod actuator interfering with a second interlocking device installed on the second drawer to thereby prevent the second drawer from being fully opened when the first drawer is in the open position.

15. The method of claim 14, further comprising:
pushing the first drawer from the open position into the piece of furniture toward the closed position;
moving the first interlocking device installed on the first drawer toward the first rod actuator installed on the rod positioned near the interior front corner of the piece of furniture;
contacting the first interlocking device with a second arm of the first rod actuator; and
rotating the rod in an opposite direction about the central axis of the rod in response to moving the first interlocking device past the first rod actuator, wherein rotation of the rod causes the second rod actuator to rotate and reset the rod into an unlocked state.

16. The method of claim 15, further comprising:
pulling the second drawer from a closed position toward an open position;
moving the second interlocking device installed on the second drawer toward the second rod actuator installed on the rod positioned near the interior front corner of the piece of furniture;
contacting the second interlocking device with a first arm of the second rod actuator;
rotating the rod about the central axis of the rod in response to moving the second interlocking device past the second rod actuator, wherein rotation of the rod causes the first rod actuator to rotate; and
precluding substantial movement of the first drawer by a second arm of the first rod actuator interfering with the first interlocking device installed on the first drawer to thereby prevent the first drawer from being fully opened when the second drawer is in the open position.

17. A method of assembly for an interlocking assembly on a piece of furniture, the method comprising:
providing a rod defining a slot along a length of the rod;
moving a first rod actuator along the length of the rod;
selecting a position along the length of the rod to install the first rod actuator;
affixing the first rod actuator to the rod;
moving a second rod actuator along the length of the rod;
selecting another position along the length of the rod to install the second rod actuator;
affixing the second rod actuator to the rod; and
installing the rod with the affixed first and second rod actuators within the piece of furniture near an interior front corner between an interior surface of a sidewall and a set of drawers.

18. The method of claim 17, further comprising:
inserting a connector through the first rod actuator and into the slot; and
inserting a second connector through the second rod actuator and into the slot.

19. The method of claim 17, further comprising:
determining a dimensional distance between the first interlocking device and the second interlocking device; and
affixing the first rod actuator and the second rod actuator at respective positions along the length of the rod based on the dimensional distance between the first interlocking device and the second interlocking device.

20. The interlocking assembly of claim 2, wherein the position setting assembly includes:
a first end and a second end, wherein the second end extends through an opening formed in a rear surface of the piece of furniture to enable a user to selectively unlock or selectively lock at least one of the first rod actuator and the second rod actuator.

21. The interlocking assembly of claim 2, wherein the position setting assembly enables a user to apply a force that causes rotational movement of the rod about the central axis of the rod.

22. The method of claim 14, further comprising:
applying a force to a position setting assembly that has an end that extends through an opening defined in a rear surface of the piece of furniture, wherein application of the force enables a user to selectively unlock or selectively lock at least one of the first rod actuator and the second rod actuator via rotational movement of the rod about the central axis.
